(19) United States
(12) Patent Application Publication
(10) Pub. No.: US 2022/0361519 A1
(43) Pub. Date: Nov. 17, 2022

(54) UMAMI-ENHANCING COMPOSITION AND METHOD FOR MANUFACTURING SAME, SEASONING OR EXTRACT AND METHOD FOR MANUFACTURING SAME, OIL AND FAT COMPOSITION FOR COOKING WITH HEAT AND METHOD FOR MANUFACTURING SAME, AND METHOD FOR ENHANCING UMAMI OF FOOD PRODUCT

(71) Applicant: J-OIL MILLS, Inc., Tokyo (JP)

(72) Inventors: Shun MATSUZAWA, Tokyo (JP); Masayoshi SAKAINO, Tokyo (JP); Misaki TSUJI, Tokyo (JP); Takahiro TOKUCHI, Tokyo (JP); Takashi SANO, Tokyo (JP)

(21) Appl. No.: 17/761,941

(22) PCT Filed: Sep. 14, 2020
(86) PCT No.: PCT/JP2020/034715

§ 371 Date: Aug. 9, 2022

(30) Foreign Application Priority Data
Sep. 30, 2019 (JP) 2019-178673

(51) Int. Cl. A23D 9/007; A23D 9/04; A23L 27/10

(52) U.S. Cl. CPC A23D 9/007; A23D 9/04; A23L 27/10

(57) ABSTRACT

To provide an edible ingredient having an exceptional effect for enhancing umami.

An umami-enhancing composition having an oxidation treatment product of a palm-based oil and fat as an active ingredient. The umami-enhancing composition can be formulated through a manufacturing method including a step in which a palm-based oil and fat in which the total α-carotene and β-carotene content is 30 mass ppm or more and 2000 mass ppm or less is subjected to an oxidation treatment such that the peroxide value reaches 3 or greater and 250 or lower. The umami-enhancing composition is optimally used as a food-product ingredient, etc., for: manufacturing a seasoning, an extract, or an oil and fat composition for cooking with heat; or enhancing the umami of a food product.

### TECHNICAL FIELD

The present invention relates to a palm-based oil and fat oxidation treatment product having an exceptional effect for enhancing umami, and to a use of said oxidation treatment product.

### BACKGROUND ART

The five original flavors that form a basis for tasting food products (basic flavors) are sweetness, sourness, saltiness, bitterness, and umami. Enhancing or reducing these flavors in food products raises the tastiness of the food products, it being desirable to enhance umami.

Patent Document 1 (International Publication No. 2011/030650) discloses adding a specific aldehyde or a specific alcohol to an aqueous solution of monosodium glutamate, which is an umami component, whereby umami is enhanced.

### RELATED ART DOCUMENTS

### Patent Documents

[Patent Document 1] International Publication No. 2011/030650

### DISCLOSURE OF THE INVENTION

### Problems the Invention is Intended to Solve

However, in view of the preferences of consumers and the increasingly diverse needs of enterprises involved in the foodstuffs trade, it has become desirable to provide novel ingredients of non-conventional origin.

It is accordingly an object of the present invention to provide an edible ingredient having an exceptional effect for enhancing umami.

### Means for Solving the Problems

According to a first aspect of the present invention, there is provided an umami-enhancing composition having an oxidation treatment product of a palm-based oil and fat as an active ingredient.

In the umami-enhancing composition described above, the peroxide value of the oxidation treatment product is preferably 3 or greater and 250 or lower.

In the umami-enhancing composition described above, the total α-carotene and β-carotene content of the palm-based oil and fat is preferably 30 mass ppm or more and 2000 mass ppm or less.

The umami-enhancing composition described above is preferably in the form of an edible oil and fat composition.

According to a second aspect of the present invention, there is provided a seasoning or extract that contains the umami-enhancing composition described above.

According to a third aspect of the present invention, there is provided an oil and fat composition for cooking with heat that contains the umami-enhancing composition described above.

According to a fourth aspect of the present invention, there is provided a method for manufacturing a heat-cooked food, the method being characterized in that a food is cooked with heat using the oil and fat composition for cooking with heat described above.

According to a fifth aspect of the present invention, there is provided a method for manufacturing an umami-enhancing composition, the method including a step in which a palm-based oil and fat in which the total α-carotene and β-carotene content is 30 mass ppm or more and 2000 mass ppm or less is subjected to an oxidation treatment such that the peroxide value reaches 3 or greater and 250 or lower.

In the method for manufacturing an umami-enhancing composition described above, the oxidation treatment is preferably carried out through heat treatment at 50° C. or greater and 220° C. or lower for 0.1 hour or more and 240 hours or less.

In the method for manufacturing an umami-enhancing composition described above, the heat treatment preferably involves supplying oxygen.

In the method for manufacturing an umami-enhancing composition described above, it is preferable that, after the step for conducting an oxidation treatment has been completed, there is furthermore included a step for mixing with an edible oil and fat.

According to a sixth aspect of the present invention, there is provided a method for manufacturing a seasoning or extract, the method including a step for mixing an umami component and an umami-enhancing composition obtained through the method for manufacturing an umami-enhancing composition described above.

According to a seventh aspect of the present invention, there is provided a method for enhancing the umami of a food product, the method involving imparting the umami-enhancing composition described above to a food product.

In the method for enhancing the umami of a food product described above, the oxidation treatment product is preferably incorporated into the food product in an amount of 1×10⁻⁶ mass ppm or more and 1000 mass ppm or less.

### Effect of the Invention

According to the present invention, it is possible to provide an edible ingredient that has an exceptional effect for enhancing umami and that is derived from palm-based oil and fat.

### MODE FOR CARRYING OUT THE INVENTION

The palm-based oil and fat used in the present invention is preferably obtained from oil palm fruit, and may be subjected to treatments such as molecular distillation, fractionation, degumming, deacidification, decoloration, and deodorization. The methods for carrying out these treatments are not particularly limited; methods that are used in processing/purification treatment of oils and fats can generally be employed. For example, fractionation can be carried out through solvent fractionation or low-temperature filtration. However, the total α-carotene and β-carotene content is preferably 30 mass ppm or more and 2000 mass ppm or less, more preferably 50 mass ppm or more and 1500 mass ppm or less, even more preferably 50 mass ppm or more and 1000 mass ppm or less, and particularly preferably 50 mass ppm or more and 800 mass ppm or less. One type of palm-based oil and fat may be used alone such that the total α-carotene and β-carotene content is within the ranges described above, or two or more types of palm-based oil and fat may be used in combination such that these ranges are reached.

In the present invention, the palm-based oil and fat is subjected to an oxidation treatment to obtain an oxidation treatment product thereof. The peroxide value (also referred to as “POV” below) of the oxidation treatment product is preferably 3 or greater and 250 or lower, more preferably 3 or greater and 220 or lower, even more preferably 3 or greater and 180 or lower, and particularly preferably 3 or greater and 150 or lower. The POV can be measured in conformance with “Standard methods for the analysis of fats, oils and related materials: 2.5.2 Peroxide value” (Japan Oil Chemists' Society). Carrying out an oxidation treatment so as to reach a POV within the prescribed ranges above makes it possible to obtain an edible ingredient having an exceptional effect for enhancing umami.

There is no particular limitation as to the method for carrying out the oxidizing treatment on the palm-based oil and fat; it is preferable to employ a method with which it is possible to achieve the POV in the prescribed ranges, preferably a heat treatment. From the standpoint of production on an industrial scale, it is preferable to accommodate the palm-based oil and fat in a suitable container, such as a tank, and then carry out the heat treatment using heating means that heats via, e.g., thermoelectric conversion, direct-flame burners, microwaves, steam, or hot blasts of air, said heating means being provided to the container. There is no particular limitation as to the conditions of the heat treatment; however, the heat treatment is preferably carried out at a heating temperature of 50° C. or greater and 220° C. or lower for a heating time of 0.1 hour or more and 240 hours or less, and more preferably carried out at a heating temperature of 60° C. or greater and 160° C. or lower for a heating time of 1 hour or more and 100 hours or less. As conditions for an integral amount obtained by multiplying heating temperature (° C.) by heating time (hours), it is typical to perform the heat treatment using an integral amount of 200 or more and 20000 or less, more typical to perform the heat treatment using an integral amount of 220 or more and 18000 or less, and even more typical to perform the heat treatment using an integral amount of 240 or more and 15000 or less. When the heating temperature is changed, the integral amount obtained by multiplying heating temperature (° C.) by heating time (hours) can be calculated as the sum of the product of the heating temperature (° C.) before the change in temperature and the heating time (hours) before the change in temperature and the product of the heating temperature (° C.) after the change in temperature and the heating time (hours) after the change in temperature, or as an integral value of the heating temperature (° C.) over the heating time (hours).

During the heat treatment, oxygen may be taken in from an open space in the container by stirring, or oxygen may be blown in, to supply the oxygen (air). Air, etc., may be used as an oxygen source. This promotes oxidation of the palm-based oil and fat. In this case, the amount of oxygen supplied is preferably set so as to reach 0.001-2 L/min per kilogram of the palm-based oil and fat. For example, when air is used, the amount supplied is preferably 0.005-10 L/min, and even more preferably 0.01-5 L/min, per kilogram of the palm-based oil and fat.

Another suitable edible oil and fat may be mixed, as appropriate, into the product of the oxidation treatment performed on the palm-based oil and fat obtained as described above, within a range in which the desired function of enhancing umami is not hindered, and an oil and fat composition that is obtained by incorporating the oxidation treatment product of the palm-based oil and fat may be formed. Examples of the other edible oil and fat include: soybean oil, rapeseed oil (canola oil), palm oil, corn oil, olive oil, sesame oil, safflower oil, sunflower oil, cottonseed oil, rice bran oil, peanut oil, palm kernel oil, coconut oil, and other vegetable oils and fats; beef tallow, lard, chicken fat, milk fat, and other animal oils and fats; and medium-chain fatty acid triglycerides, or processed oils and fats obtained by implementing fractionation, hydrogenation, transesterification, etc., on these oils and fats. One of the other edible oils and fats may be used alone, or two or more thereof may be used in combination. There is no particular limitation as to the blending ratio; however, from the standpoint of not hindering the desired function for enhancing umami, the amount of the oxidation treatment product of the palm-based oil and fat contained with respect to the total of the oxidation treatment product of the palm-based oil and fat and the other edible oil and fat is preferably 1×10⁻⁵ mass % or more and less than 100 mass %, more preferably 1×10⁻⁴ mass % or more and less than 100 mass %, even more preferably 1×10⁻³ mass % or more and less than 100 mass %, and particularly preferably 1×10⁻² mass % or more and less than 100 mass %. During blending of the oil and fat composition, one oxidation treatment product of the palm-based oil and fat may be incorporated alone into the other edible oil and fat, or two or more thereof may be used in combination.

Furthermore, suitable additives may be blended, as appropriate, into the oxidation treatment product of the palm-based oil and fat obtained as described above or into the oil and fat composition in which the same is incorporated, within a range in which the desired function of enhancing umami is not hindered. Specific examples include: fatty acid esters of ascorbic acid, lignans, coenzyme Q, γ-oryzanol, tocopherol, and other antioxidants; spices, spice extracts, animal essences, fatty acids, and other flavor-imparting ingredients; emulsifiers; silicone; and pigments.

In the present invention, the oxidation treatment product of the palm-based oil and fat and the oil and fat composition containing the same are used in enhancing umami, and specifically are used as active ingredients of an umami-enhancing composition.

In the umami-enhancing composition according to the present invention, the amount of the oxidation treatment product of the palm-based oil and fat therein is preferably determined, as appropriate, from the standpoint of reaching a desired optimal amount during application, and there is no particular limitation as to this amount. However, this amount is preferably 1×10⁻⁵ mass % or more and 100 mass % or less, more preferably 1×10⁻⁴ mass % or more and 100 mass % or less, even more preferably 1×10⁻³ mass % or more and 100 mass % or less, and particularly preferably 1×10⁻² mass' or more and 100 mass % or less.

In a discretionary non-limiting mode of the present invention, the umami-enhancing composition may be in the form of an edible oil and fat composition. Specifically, e.g., an edible oil and fat, a diluent, an auxiliary agent, an emulsifier, a pH adjuster, etc., may be discretionarily blended as needed, and an edible oil and fat composition in the form of a liquid, a powder, a paste, or another discretionary form can be produced through a publicly known method. Specifically, for example, the edible oil and fat composition may be formulated, through use of a formulation technique well known to ordinary persons skilled in the art, as a liquid oil and fat, margarine, fat spread, shortening, powdered oil and fat, etc., that mainly contains oil and fat components, or in the form of a solution, a powder, a gel, granules, etc., in which the blended amount of oil and fat components is low; these forms can be employed in a discretionary manner. In addition, for example, when the edible oil and fat composition is powderized, corn syrup or another auxiliary agent can be used, and furthermore an emulsifier may be added to formulate an emulsification raw material, which may then be powderized. Examples of means for powderization include spray-drying and freeze-drying. The oxidation treatment product formulated from the raw-material palm-based oil and fat composition in the manner described above, or the oil and fat composition containing said oxidation treatment product, may be used without modification in the one of forms as being the edible oil and fat composition.

The umami-enhancing composition according to the present invention may be used in the form of an edible oil and fat composition as described above; in that instance, the amount of the oxidation treatment product of the palm-based oil and fat is preferably determined, as appropriate, from the standpoint of reaching a desired optimal amount during application, and there is no particular limitation as to this amount. However, this amount is preferably 1×10⁻⁵ mass % or more and 100 mass % or less, more preferably 1×10⁻⁴ mass % or more and 100 mass % or less, even more preferably 1×10⁻³ mass % or more and 100 mass % or less, and particularly preferably 1×10⁻² mass % or more and 100 mass % or less.

In a discretionary non-limiting mode of the present invention, there may be provided a seasoning or extract that contains the umami-enhancing composition. Specifically, for example, the umami-enhancing composition can be added, mixed, dissolved, dispersed, emulsified, injected, etc., at a discretionary timing into a raw material for the seasoning or extract, an intermediate article of a manufacturing step, etc., whereby the umami-enhancing composition and an umami component that is a constituent element of the seasoning or extract are mixed to obtain the seasoning or extract.

In another discretionary non-limiting mode of the present invention, there may be provided an oil and fat composition for cooking with heat that contains the umami-enhancing composition. Specifically, for example, the umami-enhancing composition can be mixed with an edible oil and fat to obtain the oil and fat composition for cooking with heat. The oil and fat composition for cooking with heat can be used to fry, stir-fry, or otherwise cook with heat an umami food such as: pork, chicken, beef, and other meats from livestock animals; fish, shellfish, and other seafood; and mushrooms, thereby yielding a heat-cooked food product in which umami is enhanced.

There is no particular limitation as to the amount of the oxidation treatment product of the palm-based oil and fat contained in the oil and fat composition for cooking with heat; however, this amount is preferably 1 mass ppm or more and 100000 mass ppm or less, more preferably 10 mass ppm or more and 70000 mass ppm or less, even more preferably 100 mass ppm or more and 40000 mass ppm or less, and particularly preferably 1000 mass ppm or more and 20000 mass ppm or less. Moreover, in terms of the amount of pre-degraded carotenoids, the amount of the oxidation treatment product of the palm-based oil and fat contained in the oil and fat composition for cooking with heat is preferably 1×10⁻³ mass ppm or more and 40 mass ppm or less, more preferably 1×10⁻² mass ppm or more and 30 mass ppm or less, even more preferably 1×10⁻¹ mass ppm or more and 20 mass ppm or less, and particularly preferably 1 mass ppm or more and 10 mass ppm or less.

When the present invention is applied to a seasoning, an umami component is preferably contained in the seasoning, and there is no particular limitation as to the seasoning. Examples thereof include: monosodium glutamate, sodium inosinate, sodium guanylate, and mixtures of these; and soy sauce, miso, ketchup, and Worcester sauce.

When the present invention is applied to a seasoning, the amount of the oxidation treatment product of the palm-based oil and fat contained in the seasoning is preferably determined, as appropriate, from the standpoint of reaching a desired optimal amount during application, and there is no particular limitation as to this amount. However, this amount is preferably 1×10⁻⁴ mass ppm or more and 1000 mass ppm or less, more preferably 1×10⁻³ mass ppm or more and 500 mass ppm or less, even more preferably 1×10⁻² mass ppm or more and 200 mass ppm or less, and particularly preferably 1×10⁻¹ mass ppm or more and 100 mass ppm or less. Moreover, in terms of the amount of pre-degraded carotenoids, the amount is preferably 1×10⁻⁶ mass ppm or more and 1 mass ppm or less, more preferably 1×10⁻⁵ mass ppm or more and 1 mass ppm or less, even more preferably 1×10⁻⁴ mass ppm or more and 1 mass ppm or less, and particularly preferably 1×10⁻³ mass ppm or more and 1 mass ppm or less.

When the present invention is applied to an extract, an umami component is preferably contained in the extract, and there is no particular limitation as to the extract. Examples thereof include: marine product extracts extracted from marine products such as bonito, mackerel, scallops, oysters, and konbu; meat extracts obtained by extraction from the meat, bones, carcass, etc., of livestock animals from which pork, chicken, beef, etc., are obtained; yeast extracts extracted from yeast; and vegetable extracts extracted from various vegetables (onion, garlic, cabbage, etc.).

When the present invention is applied to an extract, the amount of the oxidation treatment product of the palm-based oil and fat contained in the seasoning is preferably determined, as appropriate, from the standpoint of reaching a desired optimal amount during application, and there is no particular limitation as to this amount. However, this amount is preferably 1×10⁻⁴ mass ppm or more and 1000 mass ppm or less, more preferably 1×10⁻³ mass ppm or more and 500 mass ppm or less, even more preferably 1×10⁻² mass ppm or more and 200 mass ppm or less, and particularly preferably 1×10⁻¹ mass ppm or more and 100 mass ppm or less. Moreover, in terms of the amount of pre-degraded carotenoids, the amount is preferably 1×10⁻⁶ mass ppm or more and 1 mass ppm or less, more preferably 1×10⁻⁵ mass ppm or more and 1 mass ppm or less, even more preferably 1×10⁻⁴ mass ppm or more and 1 mass ppm or less, and particularly preferably 1×10⁻³ mass ppm or more and 1 mass ppm or less.

In a discretionary non-limiting mode of the present invention, there may be provided a method for enhancing the umami of a food product by imparting the umami-enhancing composition to a food product. Specifically, for example, the umami-enhancing composition can be added, mixed, dissolved, dispersed, emulsified, injected, etc., at a discretionary timing into a raw material for a food product, an intermediate article of a manufacturing step, etc., whereby the umami of a food product presenting umami is enhanced. It is also possible to enhance the umami of a heat-cooked food product, obtained by frying, stir-frying, or otherwise cooking an umami food with heat, using the umami-enhancing composition in the form of an oil and fat composition for cooking with heat that is obtained by addition of the umami-enhancing composition. There is no particular limitation as to the state in which the umami-enhancing composition is imparted to the food product; said composition may not only be added, etc., to a raw material or an intermediate article of a manufacturing step, but also may be imparted to a food product by sprinkling or coating after the food product is cooked, processed, manufactured, etc.

When the present invention is applied to a food product, the amount of the oxidation treatment product of the palm-based oil and fat contained in the food product is preferably determined, as appropriate, from the standpoint of reaching a desired optimal amount during application, and there is no particular limitation as to this amount. However, the amount is preferably 1×10⁻⁶ mass ppm or more and 1000 mass ppm or less, more preferably 1×10⁵ mass ppm or more and 800 mass ppm or less, even more preferably 1×10³ mass ppm or more and 600 mass ppm or less, and particularly preferably 0.1 mass ppm or more and 500 mass ppm or less. Moreover, in terms of the amount of pre-degraded carotenoids, the amount of the oxidation treatment product of the palm-based oil and fat contained in the food product is preferably 1×10⁻¹⁰ mass ppm or more and 10 mass ppm or less, more preferably 1×10⁻⁹ mass ppm or more and mass 5 mass ppm or less, even more preferably 1×10⁻⁷ mass ppm or more and 3 mass ppm or less, and particularly preferably 1×10⁻⁵ mass ppm or more and 1 mass ppm or less.

In a discretionary non-limiting mode of the present invention, it is possible for an article formulated by adding the oxidation treatment product of the palm-based oil and fat and an article formulated in the same manner without adding the oxidation treatment product of the palm-based oil and fat to be submitted to a sensory evaluation test, preferably a sensory evaluation test carried out by a plurality of panel experts chosen from a population so as not to have a preferential tendency, to thereby conduct an objective evaluation as to whether the umami of the food product, seasoning, extract, oil and fat composition, etc., to which the present invention is applied has been enhanced.

The food product, seasoning, extract, oil and fat composition, etc., to which the present invention can be applied is not limited in scope to use for humans, but rather can be applied also to pet food, fodder, etc., for animals.

### EXAMPLES

Examples are given below to more specifically describe the present invention, but these examples do not in any way limit the present invention.

First, examples of the palm-based oil and fat used in the present example are given below, and methods for, inter alia, quantifying the α-carotene and the β-carotene are described.

(1. Palm-Based Oil and Fat)
Red palm oil 1 (molecularly distilled, fractionated one time): total α-carotene and β-carotene content was 373 mass ppm, Carotino pure olein, manufactured by Carotino
Red palm oil 2 (molecularly distilled, fractionated one time): total α-carotene and β-carotene content was 444 mass ppm, Carotino pure olein, manufactured by Carotino
Red palm oil 3 (molecularly distilled, fractionated one time): total α-carotene and β-carotene content was 457 mass ppm, Carotino pure olein, manufactured by Carotino
Red palm oil 4 (non-refined, subjected to low-temperature filtration): total α-carotene and β-carotene content was 341 mass ppm, EV redpalm oil, manufactured by Rainforest Herb
Compounded red palm oil (molecularly distilled, fractionated one time): total α-carotene and β-carotene content was 115 mass ppm, obtained by compounding red palm oil 1 and palm olein (manufactured by J-Oil Mills Inc., proprietary formulation) in ratio of 1:2 in terms of mass

(2. Quantification of α-Carotene and β-Carotene)

The α-carotene and the β-carotene were quantified by analysis through high-performance liquid chromatography (HPLC analysis). Specifically, 0.5 g of the palm-based oil and fat or the oxidation treatment product was measured out, each of these components was diluted in a measuring flask using 10 mL of acetone and tetrahydrofuran in a ratio of 1:1, the diluted components were supplied for HPLC analysis, and the α-carotene content and the β-carotene content were quantified from a calibration curve. The calibration curve was created, using a reagent (manufactured by Fujifilm Wako Pure Chemical Corp.) of α-carotene (model no. 035-17981) and β-carotene (model no. 035-05531) as a quantification formulation, from the peak area upon supply to HPLC analysis for each prescribed concentration. The primary analysis conditions are indicated below.

(HPLC Conditions)
Detector: Photodiode array detector “2996 Photodiode Array Detector” (Waters), detected at 300-600 nm
Column: Shim-pack VP-ODS, 4.6 mmID×250 mm, 4.6 μm (Shimadzu Corp.)
Column temperature: 50° C.
Injection amount: 5 μL
Flow rate: 1.2 mL/min
Mobile phase A: Acetonitrile
Mobile phase B: Ethanol
Mobile phase C: Acetone
Gradient conditions: Refer to table 1

TABLE 1
Gradient conditions

| Min | A (vol %) | B (vol %) | C (vol %) |
|---|---|---|---|
| 0 | 80 | 20 | 0 |
| 22.0 | 80 | 20 | 0 |
| 22.1 | 0 | 0 | 100 |
| 25.0 | 0 | 0 | 100 |
| 25.1 | 80 | 20 | 0 |
| 30.0 | 80 | 20 | 0 |

(3. Quantification of Hexanal)

The hexanal content was quantified under the conditions described below using a gas chromatography mass spectrometer (GC/MS). The calibration curve was created using hexanal (manufactured by Fujifilm Wako Pure Chemical Corp.).

(GC/MS Conditions)
Device: GC Agilent 7890A/MS 5975B (manufactured by Agilent Technologies, Inc.)
Column: VF-WAXms, 60 m (length)×0.25 mm (inside diameter)×0.25 μm (film thickness) (manufactured by Agilent Technologies, Inc.)
Carrier gas: Helium
Carrier flow rate: 1.2 mL/min
Injection opening: temperature 240° C., splitless
Oven: 40° C. (five min)→3° C./min→190° C. (five min)→10° C./min→240° C. (30 min)
Injection amount: 1 μL
Ionization method: EI method (70 eV)
Ion source: 250° C.
Quadrupole: 150° C.
Measurement mode: Scan
Creation of calibration curve:

Hexanal (manufactured by Fujifilm Wako Pure Chemical Corp.) was diluted, as appropriate, using acetonitrile (manufactured by Fujifilm Wako Pure Chemical Corp.) to formulate hexanal solutions from 0.125 ug/mL to 100 ug/mL. 100 μL of a 110 ug/mL 2,6-dimethyl-5-heptenal (manufactured by Sigma Aldrich)/acetonitrile solution was added as an internal standard to 1 mL of the hexanal solution to formulate a calibration curve sample. The calibration curve sample was transferred to a vial and supplied for GC/MS analysis. The calibration curve was created from the area ratio of the hexanal and the internal standard.
Quantification of Hexanal Concentration:

0.5 g of the palm-based oil and fat or the oxidation treatment product was measured out, and 100 μL of a 110 ug/mL 2,6-dimethyl-5-heptenal/acetonitrile solution was added as an internal standard. 1 mL of acetonitrile was subsequently added and vortexing was carried out for 20 minutes. The resultant solution was then subjected to centrifugal separation for five minutes at 3000 rpm using a centrifuge (Kubota Corp.). A supernatant acetonitrile phase was transferred to a vial and supplied for GC/MS analysis. The area ratio of the hexanal and the internal standard was calculated, and the hexanal concentration was calculated from a comparison with the calibration curve.

[Measurement of Peroxide Value (POV)]

The POV was measured in conformance with “Standard methods for the analysis of fats, oils and related materials: 2.5.2 Peroxide value” (Japan Oil Chemists' Society).

(4. Formulation of Oxidation Treatment Product of Oil and Fat)

The various oils and fats shown in table 2 were used to formulate oxidation treatment products thereof. Specifically, red palm oils containing α-carotene and β-carotene in prescribed amounts (mass ppm) were prepared, and the red palm oils were heat treated under the heat treatment conditions indicated in table 2 while being stirred, to obtain the oxidation treatment products in examples 1 to 6. During heat treatment, the treatment was carried out while air was blown in at a prescribed amount (0.01 L/min or 0.2 L/min). One raw-material red palm oil not subjected to heat treatment was employed as comparative example 1 as a control. A substance obtained by implementing heat treatment on rapeseed oil under the same conditions as in example 5 was employed as comparative example 2.

Table 2 shows the oil and fat used, the total α-carotene and β-carotene content of the oil and fat (carotene content), the heat treatment conditions, the total amount of α-carotene and β-carotene remaining after heat treatment (carotene remaining amount), the values of the peroxide value (POV) measured before and after heat treatment, and the hexanal concentration in the oil and fat after heat treatment.

TABLE 2

| | | | Heat treatment | | | | | |
|---|---|---|---|---|---|---|---|---|
| | | | conditions | | Carotene | | | |
| | Palm-based oil and | Carotene | | Air | remaining | POV | | |
| | fat or rapeseed | content* | Temperature | blowing | amount** | Before | After | Hexanal*** |
| | oil used | (mass ppm) | and time | amoun t | (mass ppm) | heating | heating | (mass ppm) |
| Comparative | Red palm oil | 373 | — | — | 373 | 1 | — | 0 . 6 |
| example 1 | (molecularly | | | | | | | |
| | distilled, | | | | | | | |
| | fractionated one | | | | | | | |
| | time) | | | | | | | |
| Example 1 | Red palm oil | 444 | 80° C. (182 h) | 0.2 | 0 | 1 | 80 | 35.8 |
| | (molecularly | | | L/min | | | | |
| | distilled, | | | | | | | |
| | fractionated one | | | | | | | |
| | time) | | | | | | | |
| Example 2 | Red palm oil | 457 | 103° C (53 h) | 0.01 | 0 | 1 | 115 | 64.9 |
| | (molecularly | | | L/min | | | | |
| | distilled, | | | | | | | |
| | fractionated one | | | | | | | |
| | time) | | | | | | | |
| Example 3 | Red palm oil | 373 | 120° C. (2 h) | L/min | 265 | 1 | 8 | 0.4 |
| | (molecularly | | | | | | | |
| | distilled, | | | | | | | |
| | fractionated one | | | | | | | |
| | time) | | | | | | | |
| Example 4 | Compounded red | 115 | 103° C. (64 h) | 0.2 | 0 | 1 | 216 | 303.8 |
| | palm oil | | | L/min | | | | |
| | (molecularly | | | | | | | |
| | distilled, | | | | | | | |
| | fractionated one | | | | | | | |
| | time) | | | | | | | |
| Example 5 | Red palm oil (Non- | 341 | 120° C.(5 h) → | 0.2 | 198 | 1 | 17 | 30.7 |
| | refined, subjected | | 80° C. (5 h) | L/min | | | | |
| | to low-t emperature | | | | | | | |
| | filtration) | | | | | | | |
| Example 6 | Red paim oil | 373 | 103° C. (40 h) | 0.2 | 2 | 1 | 56 | 33.1 |
| | (molecularly | | | L/min | | | | |
| | distilled, | | | | | | | |
| | fractionated one | | | | | | | |
| | time) | | | | | | | |
| Comparative | Rapeseed oil | 0 | 120° C. (5 h) → | 0.2 | 0 | 0 | 4 9 | 4 |
| example 2 | | | 80° C. (5 h) | L/min | | | | |

Carotene content*: Total α-carotene and β-carotene content
Carotene remaining amount**: Total of α-csrotene and β-carotene remaining amount
Hexanal***: Hexanal concentration of oil and fat after heat treatment

As shown in table 2, the amount of α-carotene and β-carotene contained in the red palm oil decreased due to the heat treatment; in the present formulation conditions, the α-carotene and β-carotene in the red palm oil was degraded to a greater extent by carrying out heating for a longer time or by raising the temperature. The value of the peroxide value (POV) increased due to the heat treatment. Hexanal was detected as one oxidation treatment product in the oil and fat after the heat treatment.

### [Test Example 1] (Monosodium Glutamate, Part 1)

1 g of monosodium glutamate was dissolved in 499 g of water to formulate an umami aqueous solution A containing 0.2 mass % of monosodium glutamate.

Sensory evaluation of the umami of the red palm oil in comparative example 1, or of the oxidation treatment products of the oils and fats in examples 1 to 6 and comparative example 2, was conducted using the umami aqueous solution A. Specifically, once the components were diluted with rapeseed oil, as appropriate, so as to reach the blending ratios in the upper section of table 3, the diluted components were added to the umami aqueous solution A, 2 mL of the resultant samples was retrieved, and the strength of the umami upon drinking of the samples was scored through evaluation relative to comparative example 1 according to the following criteria, to derive a median value and a mean value for the samples. The sensory evaluation was conducted by three panel experts. A “6” under the following criteria corresponds to the umami of a 0.4 mass % aqueous solution of monosodium glutamate.

(Criteria)

6 Extremely strong

5 Considerably strong

4 Strong

3 Comparatively strong

2 Somewhat strong

1 Barely strong

0 Equivalent

−1 Barely weak

−2 Somewhat weak

−3 Comparatively weak

−4 Weak

−5 Considerably weak

−6 Extremely weak

The results of the sensory evaluation are collectively shown in the lower section of table 3.

TABLE 3
(Monosodium glutamate, part 1)

| | | Formu- | Formu- | Formu- | Formu- | Formu- | Formu- |
|---|---|---|---|---|---|---|---|
| | | lation | lation | lation | lation | lation | lation |
| | | example | example | example | example | example | example |
| | | 1-1 | 1-2 | 1-3 | 1-4 | 1-5 | 1-6 |
| Oil and | Rapeseed | 0.2475 | 0.2475 | 0.2475 | 0.2475 | 0.2475 | 0.2475 |
| fat (g) | oil | | | | | | |
| | Comparative | 0.0025 | | | | | |
| | example 1 | | | | | | |
| | Example 1 | | 0.0025 | | | | |
| | Example 2 | | | 0.0025 | | | |
| | Example 3 | | | | 0.0025 | | |
| | example 4 | | | | | 0.0025 | |
| | Example 5 | | | | | | 0.0025 |
| | Example 6 | | | | | | |
| | Comparative | | | | | | |
| | example 2 | | | | | | |
| Hexanal (g) | | | | | | | |
| Umami aqueous solution | | 49.75 | 49.75 | 49.75 | 49.75 | 49.75 | 49.75 |
| A (g) | | | | | | | |
| Oil fraction (mass %) | | 0.5 | 0.5 | 0.5 | 0.5 | 0.5 | 0.5 |
| Heat-treated oil and | | — | 50 | 50 | 50 | 50 | 50 |
| fat concentration | | | | | | | |
| (mass ppm) | | | | | | | |
| Total mass (g) | | 50 | 50 | 50 | 50 | 50 | 50 |
| Heat-treated carotene* | | — | 0.0222 | 0.0225 | 0.0054 | 0.00.58 | 0.0072 |
| content (mass ppm) | | | | | | | |
| Hexanal content (mass | | 0.00003 | 0.00179 | 0.00324 | 0.00002 | 0.01515 | 0.00153 |
| ppm) | | | | | | | |
| Strength | Expert 1 | 0 | 3 | 4 | 5 | 4 | 5 |
| of umami | Expert 2 | 0 | 2 | 3 | 4 | 3 | 3 |
| | Expert 3 | 0 | 3 | 3 | 4 | 3 | 5 |

| Median value | 0 | 3 | 3 | 4 | 3 | 5 |
|---|---|---|---|---|---|---|
| Mean value | 0 | 3 | 3 | 4 | 3 | 4 |
| | | | Formu- | Formu- | Formu- | Formu- |
| | | | lation | lation | lation | lation |
| | | | example | example | example | example |
| | | | 1-7 | 1-8 | 1-9 | 1-10 |
| | Oil and | Rapeseed | 0.2475 | 0.2475 | 0.249925 | 0.24975 |
| | fat (g) | oil | | | | |
| | | Comparative | | | | |
| | | example 1 | | | | |
| | | Example 1 | | | | |
| | | Example 2 | | | | |
| | | Example 3 | | | | |
| | | example 4 | | | | |
| | | Example 5 | | | | |
| | | Example 6 | | | | |
| | | Comparative | | 0.0025 | | |
| | | example 2 | | | | |
| | Hexanal (g) | | | | 0.000075 | 0.00025 |
| | Umami aqueous solution | | 49.75 | 49.75 | 49.75 | 49.75 |
| | A (g) | | | | | |
| | Oil fraction (mass %) | | 0.5 | 0.5 | 0.5 | 0.5 |
| | Heat-treated oil and | | 50 | 50 | — | — |
| | fat concentration | | | | | |
| | (mass ppm) | | | | | |
| | Total mass (g) | | 50 | 50 | 50 | 50 |
| | Heat-treated carotene* | | 0.0186 | 0 | — | — |
| | content (mass ppm) | | | | | |
| | Hexanal content (mass | | 0.00165 | 0.00020 | 1.5** | 5.0** |
| | ppm) | | | | | |
| | Strength | Expert 1 | 5 | 1 | 0 | 1 |
| | of umami | Expert 2 | 4 | 1 | 1 | 1 |
| | | Expert 3 | 5 | 0 | 0 | 1 |

| | | | | |
|---|---|---|---|---|
| Median value | 5 | 1 | 0 | 1 |
| Mean value | 5 | 1 | 0 | 1 |

Heat-treated carotene*: Amount in terms of total α-carotene and β-carotene content prior to heat treatment
Hexanal content**: Amount calculated from added amount

According to these results, an effect for enhancing the umami of the umami aqueous solution was obtained such that the umami was stronger in formulation examples 1-2 to 1-7, which involved the use of an oxidation treatment product (examples 1 to 6) formulated by implementing heat treatment to a certain degree on red palm oil, than in formulation example 1-1, which involved the use of comparative example 1 formed from red palm oil not subjected to heat treatment. However, in formulation example 1-8, which involved the use of comparative example 2 formulated by implementing a heat treatment on rapeseed oil, and in formulations examples 1-9 and 1-10, which involved the use of hexanol, which is one oxidation treatment product, substantially no effect for enhancing the umami of the umami aqueous solution was obtained.

As described above, it has been clarified that oxidation treatment products of red palm oil exhibit an effect for enhancing the umami of an umami aqueous solution. In addition, because the same effect was not obtained using rapeseed oil that did not contain carotenes, it has been suggested that oxidation treatment products of carotenes contained in red palm oil contribute to enhancement of umami.

### [Test Example 2] (Monosodium Glutamate, Part 2)

An effect for enhancing umami was evaluated using the same method as in test example 1, except that the red palm oil in comparative example 1, and the oxidation treatment products of the oils and fats in examples 3 and 6 and comparative example 2, were added to an umami aqueous solution using the blends indicated in the upper section of table 4.

The results of the sensory evaluation are collectively shown in the lower section of table 4.

TABLE 4
(Monosodium glutamate, part 2)

| | | Formulation | Formulation | Formulation | Formulation |
|---|---|---|---|---|---|
| | | example 2-1 | example 2-2 | example 2-3 | example 2-4 |
| Oil and | Rapeseed oil | 0.24975 | 0.24975 | 0.24975 | 0.24975 |
| fat (g) | Comparative | 0.00025 | | | |
| | example 1 | | | | |
| | Example 3 | | 0.00025 | | |
| | Example 6 | | | 0.00025 | |
| | Comparative | | | | 0.00025 |
| | example 2 | | | | |
| Umami aqueous solution A (g) | | 49.75 | 49.75 | 49.75 | 49.75 |
| Oil fraction (mass %) | | 0.5 | 0.5 | 0.5 | 0.5 |
| Heat-treated oil and fat | | — | 5 | 5 | 5 |
| concentration (mass ppm) | | | | | |
| Total mass (g) | | 50 | 50 | 50 | 50 |
| Heat-treated carotene* | | — | 0.00054 | 0.00186 | 0 |
| content (mass ppm) | | | | | |
| Strength | Expert 1 | 0 | 2 | 2 | 1 |
| of umami | Expert 2 | 0 | 2 | 2 | 1 |
| | Expert 3 | 0 | 3 | 4 | 1 |

| | | | | |
|---|---|---|---|---|
| Median value | 0 | 2 | 2 | 1 |
| Mean value | 0 | 2 | 3 | 1 |

Heat-treated carotene*: Amount in terms of total α-carotene and β-carotene content prior to heat treatment

These results have clarified that the effect for enhancing the umamni of the umamni aqueous solution is obtained due to the oxidation treatment product of the red palm oil when the heat-treated carotene content (amount in terms of amount prior to heat treatment) is within the range of 0.00054 mass ppm or more.

### [Test Example 3] (Umami Seasoning)

1 g of a commercially available umami seasoning (“Ajinomoto”®, Ajinomoto Co., Inc.) was dissolved in 499 g of water to formulate an umami aqueous solution B containing 0.2 mass % of the umami seasoning.

An effect for enhancing umami was evaluated using the same method as in test example 1, except that: the umami aqueous solution B was used, and the red palm oil in comparative example 1, and the oxidation treatment products of the oils and fats in examples 1 to 6 and comparative example 2, were added to the umami aqueous solution using the blends indicated in the upper section of table 5; and the sensory evaluation was conducted by five panel experts.

The results of the sensory evaluation are collectively shown in the lower section of table 5.

TABLE 5
(Umami seasoning)

| | | Formulation | Formulation | Formulation | Formulation | Formulation | Formulation | Formulation | Formulation |
|---|---|---|---|---|---|---|---|---|---|
| | | example 3-1 | example 3-2 | example 3-3 | example 3-4 | example 3-5 | example 3-6 | example 3-7 | example 3-8 |
| Oil and | Rapeseed | 0.2475 | 0.2475 | 0.2475 | 0.2475 | 0.2475 | 0.2475 | 0.2475 | 0.2475 |
| fat (g) | oil | | | | | | | | |
| | Comparative | 0.0025 | | | | | | | |
| | example 1 | | | | | | | | |
| | Example 1 | | 0.0025 | | | | | | |
| | Example 2 | | | 0.0025 | | | | | |
| | Example 3 | | | | 0.0025 | | | | |
| | Example 4 | | | | | 0.0025 | | | |
| | Example 5 | | | | | | 0.0025 | | |
| | Example 6 | | | | | | | 0.0025 | |
| | Comparative | | | | | | | | 0.0025 |
| | example 2 | | | | | | | | |
| Umami aqueous | | 49.75 | 49.75 | 49.75 | 49.75 | 49.75 | 49.75 | 49.75 | 49.75 |
| solution B (g) | | | | | | | | | |
| Oil fraction (mass %) | | 0.5 | 0.5 | 0.5 | 0.5 | 0.5 | 0.5 | 0.5 | 0.5 |
| Heat-treated oil and | | — | 5 0 | 50 | 50 | 5 0 | 5 0 | 50 | 50 |
| fat concentration | | | | | | | | | |
| (mass ppm) | | | | | | | | | |
| Total mass (g) | | 50 | 50 | 50 | 50 | 50 | 50 | 50 | 50 |
| Heat-treated | | — | 0.0222 | 0.0229 | 0.0054 | 0.0058 | 0.0072 | 0.0186 | 0 |
| carotene* content | | | | | | | | | |
| (mass ppm) | | | | | | | | | |
| Strength | Expert 1 | 0 | 4 | 5 | 5 | 6 | 5 | 5 | 0 |
| of umami | Expert 2 | 0 | 3 | 3 | 4 | 3 | 4 | 4 | 1 |
| | Expert 3 | 0 | 3 | 4 | 2 | 5 | 2 | 4 | 1 |
| | Expert 4 | 0 | 3 | 4 | 5 | 4 | 4 | 4 | 2 |
| | Expert 5 | 0 | 2 | 4 | 2 | 0 | 2 | 2 | 0 |

| | | | | | | | | |
|---|---|---|---|---|---|---|---|---|
| Median value | 0 | 3 | 4 | 4 | 4 | 4 | 4 | 1 |
| Mean value | 0 | 3 | 4 | 4 | 4 | 3 | 4 | 1 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in a 0.2 mass % umami aqueous solution formulated using a commercially available umami seasoning.

### [Test Example 4] (Nucleic-Acid-Based Umami Component)

1 g of sodium 5′-ribonucleotide (mixture of disodium 5′-inosinate and disodium 5′-guanylate) (trade name: Ribotide, Mitsubishi Corporation Life Sciences Ltd.), which is a nucleic-acid-based umami component, was dissolved in 499 g of water to formulate an umami aqueous solution C containing 0.2 mass % of the nucleic-acid-based umami component.

An effect for enhancing umami was evaluated using the same method as in test example 1, except that the umami aqueous solution C was used, and the red palm oil in comparative example 1, and the oxidation treatment products of the oils and fats in examples 3 and 6 and comparative example 2, were added to the umami aqueous solution using the blends indicated in the upper section of table 6.

The results of the sensory evaluation are collectively shown in the lower section of table 6.

TABLE 6
(Nucleic-acid-based umami component)

| | | Formulation | Formulation | Formulation | Formulation |
|---|---|---|---|---|---|
| | | example 4-1 | example 4-2 | example 4-3 | example 4-4 |
| Oil and | Rapeseed oil | 0.2475 | 0.2475 | 0.2475 | 0.2475 |
| fat (g) | Comparative | 0.0025 | | | |
| | example 1 | | | | |
| | Example 3 | | 0.0025 | | |
| | Example 6 | | | 0.0025 | |
| | Comparative | | | | 0.0025 |
| | example 2 | | | | |
| Umami aqueous solution C (g) | | 49.75 | 49.75 | 49.75 | 49.75 |
| Oil fraction (mass %) | | 0.5 | 0.5 | 0.5 | 0.5 |
| Heat-treated oil and fat | | — | 50 | 50 | 50 |
| concentration (mass ppm) | | | | | |
| Total mass (g) | | 50 | 50 | 50 | 50 |
| Heat-treated carotene* | | — | 0.0054 | 0.0186 | 0 |
| content (mass ppm) | | | | | |
| Strength | Expert 1 | 0 | 3 | 3 | 0 |
| of umami | Expert 2 | 0 | 2 | 3 | 0 |
| | Expert 3 | 0 | 3 | 2 | 1 |

| | | | | |
|---|---|---|---|---|
| Median value | 0 | 3 | 3 | 0 |
| Mean value | 0 | 3 | 3 | 0 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in a 0.2 mass % umami aqueous solution formulated using a nucleic-acid-based umami component.

### [Test Example 5] (Chicken Stock)

4.17 g of a commercially available powdered chicken stock (trade name “Maru chicken stock,” Ajinomoto Co., Ltd.) was dissolved in 495.83 g of water to formulate an umami aqueous solution D containing 0.83 mass % of the powdered chicken stock.

An effect for enhancing umami was evaluated using the same method as in test example 1, except that the umami aqueous solution D was used, and the red palm oil in comparative example 1, and the oxidation treatment products of the oils and fats in examples 3 and 6 and comparative example 2, were added to the umami aqueous solution using the blends indicated in the upper section of table 7.

The results of the sensory evaluation are collectively shown in the lower section of table 7.

TABLE 7
(Chicken stock)

| | | Formulation | Formulation | Formulation | Formulation |
|---|---|---|---|---|---|
| | | example 5-1 | example 5-2 | example 5-3 | example 5-4 |
| Oil and | Rapeseed oil | 0.2475 | 0.2475 | 0.2475 | 0.2475 |
| fat (g) | Comparative | 0.0025 | | | |
| | example 1 | | | | |
| | Example 3 | | 0.0025 | | |
| | Example 6 | | | 0.0025 | |
| | Comparative | | | | 0.0025 |
| | example 2 | | | | |
| Umami aqueous solution D (g) | | 49.75 | 49.75 | 49.75 | 49.75 |
| Oil fraction (mass %) | | 0.5 | 0.5 | 0.5 | 0.5 |
| Heat-treated oil and fat | | — | 50 | 50 | 50 |
| concentration (mass ppm) | | | | | |
| Total mass (g) | | 50 | 50 | 50 | 50 |
| Heat-treated carotene* | | — | 0.0054 | 0.0186 | 0 |
| content (mass ppm) | | | | | |
| Strength | Expert 1 | 0 | 2 | 3 | 1 |
| of umami | Expert 2 | 0 | 4 | 3 | 0 |
| | Expert 3 | 0 | 3 | 3 | 0 |

| | | | | |
|---|---|---|---|---|
| Median value | 0 | 3 | 3 | 0 |
| Mean value | 0 | 3 | 3 | 0 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in a 0.83 mass % umami aqueous solution formulated using commercially available powdered chicken stock.

### [Test Example 6] (Powdered Bonito Stock)

3.33 g of a commercially available powdered bonito stock (“Hondashi”®, Ajinomoto Co., Ltd.) was dissolved in 496.67 g of water to formulate an umami aqueous solution E containing 0.67 mass % of the powdered bonito stock.

An effect for enhancing umami was evaluated using the same method as in test example 1, except that the umami aqueous solution E was used, and the red palm oil in comparative example 1, and the oxidation treatment products of the oils and fats in examples 3 and 6 and comparative example 2, were added to the umami aqueous solution using the blends indicated in the upper section of table 8.

The results of the sensory evaluation are collectively shown in the lower section of table 8.

TABLE 8
(Powdered bonito stock)

| | | Formulation | Formulation | Formulation | Formulation |
|---|---|---|---|---|---|
| | | example 6-1 | example 6-2 | example 6-3 | example 6-4 |
| Oil and | Rapeseed oil | 0.2475 | 0.2475 | 0.2475 | 0.2475 |
| fat (g) | Comparative | 0.0025 | | | |
| | example 1 | | | | |
| | Example 3 | | 0.0025 | | |
| | Example 6 | | | 0.0025 | |
| | Comparative | | | | 0.0025 |
| | example 2 | | | | |
| Umami aqueous solution E (g) | | 49.75 | 49.75 | 49.75 | 49.75 |
| Oil fraction (mass %) | | 0.5 | 0.5 | 0.5 | 0.5 |
| Heat-treated oil and fat | | — | 50 | 50 | 50 |
| concentration (mass ppm) | | | | | |
| Total mass (g) | | 50 | 50 | 50 | 50 |
| Heat-treated carotene* | | — | 0.0054 | 0.0186 | 0 |
| content (mass ppm) | | | | | |
| Strength | Expert 1 | 0 | 1 | 2 | 0 |
| of umami | Expert 2 | 0 | 4 | 3 | 1 |
| | Expert 3 | 0 | 3 | 4 | 0 |

| | | | | |
|---|---|---|---|---|
| Median value | 0 | 3 | 3 | 0 |
| Mean value | 0 | 3 | 3 | 0 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in a 0.67 mass % umami aqueous solution formulated using commercially available powdered bonito stock.

### [Test Example 7] (Powdered Konbu Stock)

3.33 g of a commercially available powdered konbu stock (“Hondashi”, konbu stock, Ajinomoto Co., Ltd.) was dissolved in 496.67 g of water to formulate an umami aqueous solution F containing 0.67 mass % of the powdered konbu stock.

An effect for enhancing umami was evaluated using the same method as in test example 1, except that the umami aqueous solution F was used, and the red palm oil in comparative example 1, and the oxidation treatment products of the oils and fats in examples 3 and 6 and comparative example 2, were added to the umami aqueous solution using the blends indicated in the upper section of table 9.

The results of the sensory evaluation are collectively shown in the lower section of table 9.

TABLE 9
(Powdered konbu stock)

| | | Formulation | Formulation | Formulation | Formulation |
|---|---|---|---|---|---|
| | | example 7-1 | example 7-2 | example 7-3 | example 7-4 |
| Oil and | Rapeseed oil | 0.2475 | 0.2475 | 0.2475 | 0.2475 |
| fat (g) | Comparative | 0.0025 | | | |
| | example 1 | | | | |
| | Example 3 | | 0.0025 | | |
| | Example 6 | | | 0.0025 | |
| | Comparative | | | | 0.0025 |
| | example 2 | | | | |
| Umami aqueous solution F (g) | | 49.75 | 49.75 | 49.75 | 49.75 |
| Oil fraction (mass %) | | 0.5 | 0.5 | 0.5 | 0.5 |
| Heat-treated oil and fat | | — | 50 | 50 | 50 |
| concentration (mass ppm) | | | | | |
| Total mass (g) | | 50 | 50 | 50 | 50 |
| Heat-treated carotene* | | — | 0.0054 | 0.0186 | 0 |
| content (mass ppm) | | | | | |
| Strength | Expert 1 | 0 | 2 | 2 | 0 |
| of umami | Expert 2 | 0 | 2 | 1 | 0 |
| | Expert 3 | 0 | 2 | 3 | −1 |

| | | | | |
|---|---|---|---|---|
| Median value | 0 | 2 | 2 | 0 |
| Mean value | 0 | 2 | 2 | 0 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in a 0.67 mass % umami aqueous solution formulated using commercially available powdered konbu stock.

### [Test Example 8] (Consommé)

4.17 g of solid consommé (trade name “Ajinomoto KK consommé,” Ajinomoto Co., Ltd.) was dissolved in 495.83 g of water to formulate an umami aqueous solution G containing 0.83 mass, of the solid consommé.

An effect for enhancing umami was evaluated using the same method as in test example 1, except that the umami aqueous solution G was used, and the red palm oil in comparative example 1, and the oxidation treatment products of the oils and fats in examples 3 and 6 and comparative example 2, were added to the umami aqueous solution using the blends indicated in the upper section of table 10.

The results of the sensory evaluation are collectively shown in the lower section of table 10.

TABLE 10
(Consommé)

| | | Formulation | Formulation | Formulation | Formulation |
|---|---|---|---|---|---|
| | | example 8-1 | example 8-2 | example 8-3 | example 8-4 |
| Oil and | Rapeseed oil | 0.2475 | 0.2475 | 0.2475 | 0.2475 |
| fat (g) | Comparative | 0.0025 | | | |
| | example 1 | | | | |
| | Example 3 | | 0.0025 | | |
| | Example 6 | | | 0.0025 | |
| | Comparative | | | | 0.0025 |
| | example 2 | | | | |
| Umami aqueous solution G (g) | | 49.75 | 49.75 | 49.75 | 49.75 |
| Oil fraction (mass %) | | 0.5 | 0.5 | 0.5 | 0.5 |
| Heat-treated oil and fat | | — | 50 | 50 | 50 |
| concentration (mass ppm) | | | | | |
| Total mass (g) | | 50 | 50 | 50 | 50 |
| Heat-treated carotene* | | — | 0.0054 | 0.0186 | 0 |
| content (mass ppm) | | | | | |
| Strength | Expert 1 | 0 | 4 | 5 | 2 |
| of umami | Expert 2 | 0 | 2 | 3 | 0 |
| | Expert 3 | 0 | 1 | 1 | 0 |

| | | | | |
|---|---|---|---|---|
| Median value | 0 | 2 | 3 | 0 |
| Mean value | 0 | 2 | 3 | 1 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in a 0.83 mass % umami aqueous solution formulated using solid consommé.

### [Test Example 9] (Pork Extract)

6 g of a pork extract (product name: Pork stock 50-10-N, DSP Gokyo Food & Chemical Co., Ltd.) was dissolved in 494 g of water to formulate an umami aqueous solution H containing 1.2 mass, of the pork extract.

An effect for enhancing umami was evaluated using the same method as in test example 1, except that the umami aqueous solution H was used, and the red palm oil in comparative example 1, and the oxidation treatment products of the oils and fats in examples 3 and 6 and comparative example 2, were added to the umami aqueous solution using the blends indicated in the upper section of table 11.

The results of the sensory evaluation are collectively shown in the lower section of table 11.

TABLE 11
(Pork extract)

| | | Formulation | Formulation | Formulation | Formulation |
|---|---|---|---|---|---|
| | | example 9-1 | example 9-2 | example 9-3 | example 9-4 |
| Oil and | Rapeseed oil | 0.2475 | 0.2475 | 0.2475 | 0.2475 |
| fat (g) | Comparative | 0.0025 | | | |
| | example 1 | | | | |
| | Example 3 | | 0.0025 | | |
| | Example 6 | | | 0.0025 | |
| | Comparative | | | | 0.0025 |
| | example 2 | | | | |
| Umami aqueous solution H (g) | | 49.75 | 49.75 | 49.75 | 49.75 |
| Oil fraction (mass %) | | 0.5 | 0.5 | 0.5 | 0.5 |
| Heat-treated oil and fat | | — | 50 | 50 | 50 |
| concentration (mass ppm) | | | | | |
| Total mass (g) | | 50 | 50 | 50 | 50 |
| Heat-treated carotene* | | — | 0.0054 | 0.0186 | 0 |
| content (mass ppm) | | | | | |
| Strength | Expert 1 | 0 | 3 | 3 | 1 |
| of umami | Expert 2 | 0 | 1 | 1 | 0 |
| | Expert 3 | 0 | 3 | 2 | 0 |

| | | | | |
|---|---|---|---|---|
| Median value | 0 | 3 | 2 | 0 |
| Mean value | 0 | 2 | 2 | 0 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in a 1.2 mass umami aqueous solution formulated using a pork extract.

### [Test Example 10] (Beef Extract)

6 g of a beef extract (product name: Adipol beef UP, DSP Gokyo Food & Chemical Co., Ltd.) was dissolved in 494 g of water to formulate an umami aqueous solution I containing 1.2 mass, of the beef extract.

An effect for enhancing umami was evaluated using the same method as in test example 1, except that the umami aqueous solution I was used, and the red palm oil in comparative example 1, and the oxidation treatment products of the oils and fats in examples 3 and 6 and comparative example 2, were added to the umami aqueous solution using the blends indicated in the upper section of table 12.

The results of the sensory evaluation are collectively shown in the lower section of table 12.

TABLE 12
(Beef extract)

| | | Formulation | Formulation | Formulation | Formulation |
|---|---|---|---|---|---|
| | | example 10-1 | example 10-2 | example 10-3 | example 10-4 |
| Oil and | Rapeseed oil | 0.2475 | 0.2475 | 0.2475 | 0.2475 |
| fat (g) | Comparative | 0.0025 | | | |
| | example 1 | | | | |
| | Example 3 | | 0.0025 | | |
| | Example 6 | | | 0.0025 | |
| | Comparative | | | | 0.0025 |
| | example 2 | | | | |
| Umami aqueous solution I (g) | | 49.75 | 49.75 | 49.75 | 49.75 |
| Oil fraction (mass %) | | 0.5 | 0.5 | 0.5 | 0.5 |
| Heat-treated oil and fat | | — | 50 | 50 | 50 |
| concentration (mass ppm) | | | | | |
| Total mass (g) | | 50 | 50 | 50 | 50 |
| Heat-treated carotene* | | — | 0.0054 | 0.0186 | 0 |
| content (mass ppm) | | | | | |
| Strength | Expert 1 | 0 | 5 | 6 | 2 |
| of umami | Expert 2 | 0 | 3 | 4 | 1 |
| | Expert 3 | 0 | 4 | 3 | 3 |

| | | | | |
|---|---|---|---|---|
| Median value | 0 | 4 | 4 | 2 |
| Mean value | 0 | 4 | 4 | 2 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in a 1.2 mass % umami aqueous solution formulated using a beef extract.

### [Test Example 11] (Yeast Extract)

6 g of a yeast extract (product name: Aromild, DSP Gokyo Food & Chemical Co., Ltd.) was dissolved in 494 g of water to formulate an umami aqueous solution J containing 1.2 mass, of the yeast extract.

An effect for enhancing umami was evaluated using the same method as in test example 1, except that the umami aqueous solution J was used, and the red palm oil in comparative example 1, and the oxidation treatment products of the oils and fats in examples 3 and 6 and comparative example 2, were added to the umami aqueous solution using the blends indicated in the upper section of table 13.

The results of the sensory evaluation are collectively shown in the lower section of table 13.

TABLE 13
(Yeast extract)

| | | Formulation | Formulation | Formulation | Formulation |
|---|---|---|---|---|---|
| | | example 11-1 | example 11-2 | example 11-3 | example 11-4 |
| Oil and | Rapeseed oil | 0.2475 | 0.2475 | 0.2475 | 0.2475 |
| fat (g) | Comparative | 0.0025 | | | |
| | example 1 | | | | |
| | Example 3 | | 0.0025 | | |
| | Example 6 | | | 0.0025 | |
| | Comparative | | | | 0.0025 |
| | example 2 | | | | |
| Umami aqueous solution J (g) | | 49.75 | 49.75 | 49.75 | 49.75 |
| Oil fraction (mass %) | | 0.5 | 0.5 | 0.5 | 0.5 |
| Heat-treated oil and fat | | — | 50 | 50 | 50 |
| concentration (mass ppm) | | | | | |
| Total mass (g) | | 50 | 50 | 50 | 50 |
| Heat-treated carotene* | | — | 0.0054 | 0.0186 | 0 |
| content (mass ppm) | | | | | |
| Strength | Expert 1 | 0 | 1 | 2 | 0 |
| of umami | Expert 2 | 0 | 2 | 2 | 0 |
| | Expert 3 | 0 | 2 | 2 | 0 |

| | | | | |
|---|---|---|---|---|
| Median value | 0 | 2 | 2 | 0 |
| Mean value | 0 | 2 | 2 | 0 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in a 1.2 mass % umami aqueous solution formulated using a yeast extract.

### [Test Example 12] (Konbu Stock, Part 1)

20 g of konbu was introduced into 1000 g of water, the mixture was heated over medium heat until just before boiling, and then the konbu was removed to formulate a konbu stock.

An effect for enhancing umami was evaluated using the same method as in test example 1, except that the konbu stock was used as an umami aqueous solution K, and the red palm oil in comparative example 1, and the oxidation treatment products of the oils and fats in examples 3 and 6 and comparative example 2, were added to the umami aqueous solution using the blends indicated in the upper section of table 14.

The results of the sensory evaluation are collectively shown in the lower section of table 14.

TABLE 14
(Konbu stock, part 1)

| | | Formulation | Formulation | Formulation | Formulation |
|---|---|---|---|---|---|
| | | example 12-1 | example 12-2 | example 12-3 | example 12-4 |
| Oil and | Rapeseed oil | 0.2475 | 0.2475 | 0.2475 | 0.2475 |
| fat (g) | Comparative | 0.0025 | | | |
| | example 1 | | | | |
| | Example 3 | | 0.0025 | | |
| | Example 6 | | | 0.0025 | |
| | Comparative | | | | 0.0025 |
| | example 2 | | | | |
| Umami aqueous solution K (g) | | 49.75 | 49.75 | 49.75 | 49.75 |
| Oil fraction (mass %) | | 0.5 | 0.5 | 0.5 | 0.5 |
| Heat-treated oil and fat | | — | 50 | 50 | 50 |
| concentration (mass ppm) | | | | | |
| Total mass (g) | | 50 | 50 | 50 | 50 |
| Heat-treated carotene* | | — | 0.0054 | 0.0186 | 0 |
| content (mass ppm) | | | | | |
| Strength | Expert 1 | 0 | 1 | 2 | 0 |
| of umami | Expert 2 | 0 | 2 | 2 | 1 |
| | Expert 3 | 0 | 3 | 4 | 0 |

| | | | | |
|---|---|---|---|---|
| Median value | 0 | 2 | 2 | 0 |
| Mean value | 0 | 2 | 3 | 0 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil even in an umami aqueous solution formed from konbu stock.

### [Test Example 13] (Konbu Stock, Part 2)

<Formulation of Powdered Oil and Fat>

A powdered oil and fat in which there was incorporated 1 mass % of the oxidation treatment product in example 6 formulated in test example 1 was formulated using the blend shown in table 15 (example 7). The powdered oil and fat was formulated in conformance with the disclosures in Japanese Unexamined Patent Publication No. 2017-63784 (paragraph [0046]). In addition, a powdered oil and fat serving as a control was formulated using the same method, except that no oxidation treatment product was blended therein (comparative example 3).

TABLE 15

| | | Comparative | Example 7 |
|---|---|---|---|
| | | example 3 | (parts by |
| Raw material | | (pacts by mass) | mass |
| Oil | Ultrahardened palm | 45 | 44 |
| phase | kernel oil | | |
| | Oxidation treatment | — | 1 |
| | product of oil and | | |
| | fat in example 6 | | |
| | Emulsifier | 0.9 | 0.9 |
| Aqueous | Corn syrup | 47.5 | 47.5 |
| phase | Acid casein | 4.399 | 4.399 |
| | Sodium hydroxide | 0.101 | 0.101 |
| | pH adjuster | 2.1 | 2.1 |
| Total | | 100 | 100 |

| | | |
|---|---|---|
| Oil and fat content of powdered oil | 45 mass % | 45 mass % |
| and fat | | |
| Oxidation treatment product content of | — | 1 mass % |
| powdered oil and fat | | |

An effect for enhancing umami was evaluated using the same method as in test example 12, except that: the powdered oil and fat in comparative example 3, and the powdered oil and fat in example 7, were added to the umami aqueous solution using the blends indicated in the upper section of table 16; and the evaluation was carried out through comparison relative to comparative example 3 rather than to comparative example 1.

The results of the sensory evaluation are collectively shown in the lower section of table 16.

TABLE 16
(Konbu stock, part 2)

| | | Formulation | Formulation |
|---|---|---|---|
| | | example 13-1 | example 13-2 |
| Powdered oil | Comparative | 0.5 | |
| and fat (g) | example 3 | | |
| | Example 7 | | 0.5 |
| Umami aqueous | | 49.5 | 49.5 |
| solution K (g) | | | |
| Oil fraction (mass %) | | 0.45 | 0.45 |
| Heat-treated oil and | | — | 50 |
| fat concentration | | | |
| (mass ppm) | | | |
| Total mass (g) | | 50 | 50 |
| Heat-treated | | — | 0.0186 |
| carotene* content | | | |
| (mass ppm) | | | |
| Strength | Expert 1 | 0 | 2 |
| of umami | Expert 2 | 0 | 2 |
| | Expert 3 | 0 | 3 |

| | | |
|---|---|---|
| Median | 0 | 2 |
| Mean | 0 | 2 |

Heat-treated carotene*: Amount in terms of total α-carotene and β-carotene content prior to heat treatment

These results have clarified that the effect for enhancing the umami of the umami aqueous solution is obtained due to the oxidation treatment product of the red palm oil in an umami aqueous solution formed from konbu stock, even when the oxidation treatment product of the red palm oil is formulated as a powdered oil and fat.

### [Test Example 14] (Tatsuta-Age)

An effect for enhancing umami when cooking tatsuta-age was examined using an oil and fat composition for cooking with heat in which the oxidation treatment product of the red palm oil was blended.

<Formulation of Oil and Fat Composition for Cooking with Heat>

The oxidation treatment product of the oil and fat in example 6 was mixed with canola oil for frying (J-canola oil, manufactured by J-Oil Mills, Inc.) using the blend indicated in the upper section of table 17 to formulate an oil and fat composition for cooking with heat.

(Formulation and Evaluation of Tatsuta-Age)

(1) Pure-rice cooking sake (Toashuzo Co., Ltd.) and soy sauce were mixed in a ratio of 2:1 (mass ratio) to formulate a liquid seasoning.

(2) 30 parts by mass of the liquid seasoning was introduced into a plastic bag, a further 100 parts by mass of chicken thigh that was cut to about 30 g was introduced therein, and the chicken thigh was immersed for 20 minutes.

(3) The chicken thigh was removed from the plastic bag and excess liquid was drained, after which the chicken thigh was coated with potato starch.

(4) The chicken thigh coated with the potato starch was fried for six minutes using the oil and fat composition for cooking with heat, which had been heated to 180° C., to obtain tatsuta-age.

The resultant tatsuta-age was eaten to conduct a sensory evaluation of umami. Specifically, scoring was carried out through evaluation relative to formulation example 14-1, which did not contain the oxidation treatment product of the red palm oil, according to the following criteria, to derive a median value and a mean value for the samples. The sensory evaluation was conducted by six panel experts.

(Criteria)

6 Extremely strong

5 Considerably strong

4 Strong

3 Comparatively strong

2 Somewhat strong

1 Barely strong

0 Equivalent

−1 Barely weak

−2 Somewhat weak

−3 Comparatively weak

−4 Weak

−5 Considerably weak

−6 Extremely weak

The results of the sensory evaluation are collectively shown in the lower section of table 17.

TABLE 17
(Tatsuta-age)

| | | Formulation | Formulation | Formulation |
|---|---|---|---|---|
| | | example 14-1 | example 14-2 | example 14-3 |
| Oil and | Rapeseed | 600 | 597 | 594 |
| fat (g) | oil for | | | |
| | frying | | | |
| | Example 6 | | 3 | 6 |
| Heat-treated oil and | | — | 5000 | 10000 |
| fat concentration | | | | |
| (mass ppm) | | | | |
| Total mass (g) | | 600 | 600 | 600 |
| Heat-treated | | — | 1.86 | 3.71 |
| carotene* content | | | | |
| (mass ppm) | | | | |
| Strength | Expert 1 | 0 | 2 | 4 |
| of umami | Expert 2 | 0 | 1 | 1 |
| | Expert 3 | 0 | 1 | 3 |
| | Expert 4 | 0 | 0 | 2 |
| | Expert 5 | 0 | 2 | 2 |
| | Expert 6 | 0 | 0 | 2 |

| | | | |
|---|---|---|---|
| Median value | 0 | 1 | 2 |
| Mean value | 0 | 1 | 2 |

Heat-treated carotene*: Amount in terms of total α-carotene and β-carotene content prior to heat treatment

These results have clarified that the effect for enhancing the umami of tatsuta-age is obtained such that the umami is stronger in tatsuta-age fried using an oil and fat composition for cooking with heat that contains the oxidation treatment product of the red palm oil than in tatsuta-age fried using an oil and fat composition for cooking with heat that does not contain the oxidation treatment product of the red palm oil, due to the oxidation treatment product of the red palm oil in the former.

1. An umami-enhancing composition having an oxidation treatment product of a palm-based oil and fat as an active ingredient.

2. The umami-enhancing composition according to claim 1, wherein the peroxide value of the oxidation treatment product is 3 or greater and 250 or lower.

3. The umami-enhancing composition according to claim 1 or 2, wherein the total α-carotene and β-carotene content of the palm-based oil and fat is 30 mass ppm or more and 2000 mass ppm or less.

4. The umami-enhancing composition according to any of claims 1 to 3, wherein the umami-enhancing composition is in the form of an edible oil and fat composition.

5. A seasoning or extract that contains the umami-enhancing composition according to any of claims 1 to 4.

6. An oil and fat composition for cooking with heat that contains the umami-enhancing composition according to any of claims 1 to 4.

7. A method for manufacturing a heat-cooked food, the method being characterized in that a food is cooked with heat using the oil and fat composition for cooking with heat according to claim 6.

8. A method for manufacturing an umami-enhancing composition, the method including a step in which a palm-based oil and fat in which the total α-carotene and β-carotene content is 30 mass ppm or more and 2000 mass ppm or less is subjected to an oxidation treatment such that the peroxide value reaches 3 or greater and 250 or lower.

9. The method for manufacturing an umami-enhancing composition according to claim 8, wherein the oxidation treatment is carried out through heat treatment at 50° C. or greater and 220° C. or lower for 0.1 hour or more and 240 hours or less.

10. The method for manufacturing an umami-enhancing composition according to claim 9, wherein the heat treatment involves supplying oxygen.

11. The method for manufacturing an umami-enhancing composition according to any of claims 8 to 10, wherein, after the step for conducting an oxidation treatment has been completed, there is furthermore included a step for mixing with an edible oil and fat.

12. A method for manufacturing a seasoning or extract, the method including a step for mixing an umami component and an umami-enhancing composition obtained through the manufacturing method according to any of claims 8 to 10.

13. A method for enhancing the umami of a food product, the method involving imparting the umami-enhancing composition according to any of claim 1 to 4 to a food product.

14. The method for enhancing the umami of a food product according to claim 13, wherein the oxidation treatment product is incorporated into the food product in an amount of 1×10⁻⁶ mass ppm or more and 1000 mass ppm or less.
